(19) United States
(12) Patent Application Publication
(10) Pub. No.: US 2011/0118040 A1
(43) Pub. Date: May 19, 2011

(54) GOLF SIMULATOR APPARATUS AND RELATED METHODS

(75) Inventors: David L. Ashby, Bountiful, UT (US); Christopher L. Jones, Bountiful, UT (US); Ryan L. Jones, North Salt Lake, UT (US); Steven R. Johnson, Centerville, UT (US); Derrick Thompson, West Jordan, UT (US)

(73) Assignee: TRUGOLF, INC., Centerville, UT (US)

(21) Appl. No.: 12/945,716

(22) Filed: Nov. 12, 2010

Related U.S. Application Data
(60) Provisional application No. 61/261,216, filed on Nov. 13, 2009.

(51) Int. Cl. A63B 67/02; A63B 69/36; A63F 13/08

(52) U.S. Cl. 473/156; 473/225; 473/190; 473/409

(57) ABSTRACT

Collapsible golf simulators include an enclosure mounted over a base. The base has a play surface configured to support a person using the golf simulator, and the enclosure is configured to receive golf balls hit from the play surface. A container is configured to be removably mounted to the base, and at least one component of at least one of a computer system and a graphical display system is disposed within the container. In additional embodiments, collapsible golf simulators include a collapsible enclosure mounted over a base. The enclosure is configured to receive a physical golf ball hit from a play surface on the base. The collapsible enclosure includes a plurality of arcuate rib members each having ends pivotally mounted to the base. The rib members are configured to pivot relative to the base and carry a sheet of pliable material. Methods of using such apparatuses are also disclosed.

### CROSS-REFERENCE TO RELATED APPLICATION

This application claims the benefit of U.S. Provisional Patent Application Ser. No. 61/261,216 to Ashby et al., filed Nov. 13, 2009, the disclosure of which is hereby incorporated herein in its entirety by this reference.

### TECHNICAL FIELD

Embodiments of the invention relate to apparatuses for simulating play of the game of golf, and to methods of making and using such apparatuses.

### BACKGROUND

Golf simulators are used to simulate physical golf play in an at least partially virtual environment. In some golf simulators, a person using the golf simulator physically swings a physical golf club at a physical golf ball. One or more sensors are used to obtain information about the physical swing or “stroke,” and the information is input into a computer system. The computer comprises a computer program, such as a golf game, that uses the information to generate a virtual stroke and resulting virtual golf ball trajectory on a virtual golf course within the computer program. Thus, the golf simulator simulates the actual, physical golf stroke in the form of a virtual golf stroke created within the computer system using information obtained from the actual, physical stroke performed by the person using the simulator.

Various types of golf simulators are known in the art as disclosed in, for example, U.S. Pat. No. 4,086,630, which issued Apr. 25, 1978 to Speiser et al.; U.S. Pat. No. 5,056,791, which issued Oct. 15, 1991 to Poillon et al.; U.S. Pat. No. 5,354,063, which issued Oct. 11, 1994 to Curchod; U.S. Pat. No. 5,390,927, which issued Feb. 21, 1995 to Angelos; U.S. Pat. No. 5,718,639, which issued Feb. 17, 1998 to Bouton; U.S. Pat. No. 5,846,139, which issued Dec. 8, 1998 to Bair et al.; and U.S. Pat. No. 6,595,863, which issued Jul. 22, 2003 to Chamberlain et al.

### BRIEF SUMMARY

In some embodiments, the present invention includes golf simulator apparatuses that include a computer system, a graphical display system in electrical communication with the computer system, and a physical golf stroke sensing system. The computer system includes a computer program configured to simulate golf play, and the graphical display system is configured to display images generated by the computer program. The golf stroke sensing system communicates electrically with the computer system and is configured to sense at least one characteristic of a physical stroke of a physical golf club against a physical golf ball by a person using the golf simulator apparatus, and to input information relating to the at least one characteristic into the computer system. The computer program is configured to simulate a virtual golf stroke in the computer program using the information relating to the at least one characteristic of the physical stroke of the physical golf club against the physical golf ball. The apparatuses further comprise a stage that includes a base having a play surface configured to support a person using the golf simulator apparatus, and an enclosure mounted over the base and configured to receive a physical golf ball hit from the play surface by a person using the golf simulator apparatus upon stroke of a physical golf club against the physical golf ball by the person using the golf simulator apparatus. The apparatuses also include a container configured to be removably mounted to the base of the stage, and at least one component of at least one of the computer system and the graphical display system is disposed within the container.

In additional embodiments, the present invention includes golf simulator apparatuses that include a computer system, a graphical display system in electrical communication with the computer system, and a physical golf stroke sensing system in electrical communication with the computer system. The computer system comprises a computer program that is configured to simulate golf play, and the graphical display system is configured to display images generated by the computer program. The golf stroke sensing system is configured to sense at least one characteristic of a physical stroke of a physical golf club against a physical golf ball by a person using the golf simulator apparatus, and to input information relating to the at least one characteristic into the computer system. The computer program is configured to simulate a virtual golf stroke in the computer program using the information relating to the at least one characteristic of the physical stroke of the physical golf club against the physical golf ball. The apparatuses further include a collapsible stage configured to transform between a collapsed configuration, in which the collapsible stage is configured for at least one of transportation and storage, and an expanded configuration, in which the collapsible stage is configured for use in simulating golf play. The collapsible stage includes a base having a play surface configured to support a person using the golf simulator apparatus, and a collapsible enclosure mounted over the base and configured to receive a physical golf ball hit from the play surface by a person using the golf simulator apparatus upon stroke of a physical golf club against the physical golf ball by the person using the golf simulator apparatus. The collapsible enclosure includes a plurality of arcuate rib members, each of which has a first end pivotally mounted to the base at a first lateral side thereof, and an opposite, second end pivotally mounted to the base at a second lateral side thereof. Each arcuate rib member of the plurality of arcuate rib members is configured to pivot relative to the base between an extended position and a collapsed position. Furthermore, a sheet of pliable material is carried by the plurality of arcuate rib members.

In additional embodiments, the present invention includes methods of transporting or storing a golf simulator apparatus. The methods include collapsing a collapsible enclosure from an expanded configuration to a collapsed configuration, and folding the collapsed enclosure and a base attached to the collapsed enclosure to reduce a maximum footprint area of the golf simulator apparatus and a volume of space occupied by the golf simulator. In the expanded configuration, the collapsible enclosure is configured for use in simulating golf play. In the collapsed configuration, the collapsible enclosure is configured for at least one of transportation and storage.

### BRIEF DESCRIPTION OF THE SEVERAL VIEWS OF THE DRAWINGS

While the specification concludes with claims particularly pointing out and distinctly claiming what are regarded as embodiments of the invention, the advantages of embodiments of the invention may be more readily ascertained from the description of examples of embodiments of the invention below, when read in conjunction with the accompanying drawings, in which:

FIG. 1 is a perspective view of an embodiment of a collapsible golf simulator apparatus of the present invention in an expanded state;

FIG. 2 is a front plan view of the collapsible golf simulator shown in FIG. 1;

FIG. 3 is a schematic diagram illustrating various components of the golf simulator shown in FIGS. 1 and 2; and

FIGS. 4A-4I illustrate the golf simulator apparatus shown in FIGS. 1 through 3 in various configurations attained as the golf simulator apparatus is collapsed for transportation, storage, or both transportation and storage.

### DETAILED DESCRIPTION

Illustrations presented herein are not meant to be actual views of any particular golf simulator apparatus, or component thereof, but are merely idealized representations that are employed to describe embodiments of the invention. Additionally, elements common between figures may retain the same numerical designation.

As used herein, a “physical” object (such as a physical golf club or a physical golf ball) means a real object formed of and comprising a volume of matter that occupies a volume of three-dimensional space. As used herein, a “virtual” object is an object that is not a physical object, but rather an object that is simulated on or by a computer system and represented by a graphical image or images using a graphical display device.

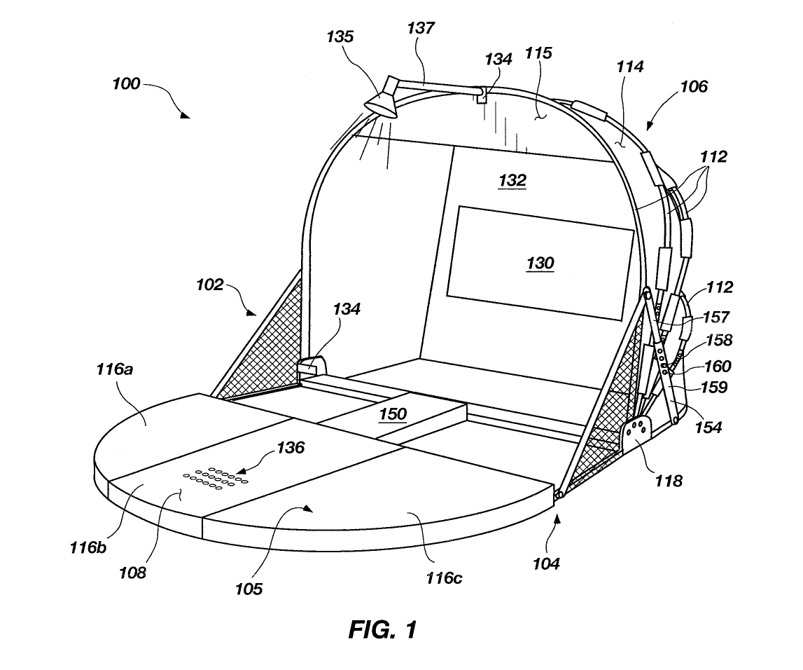

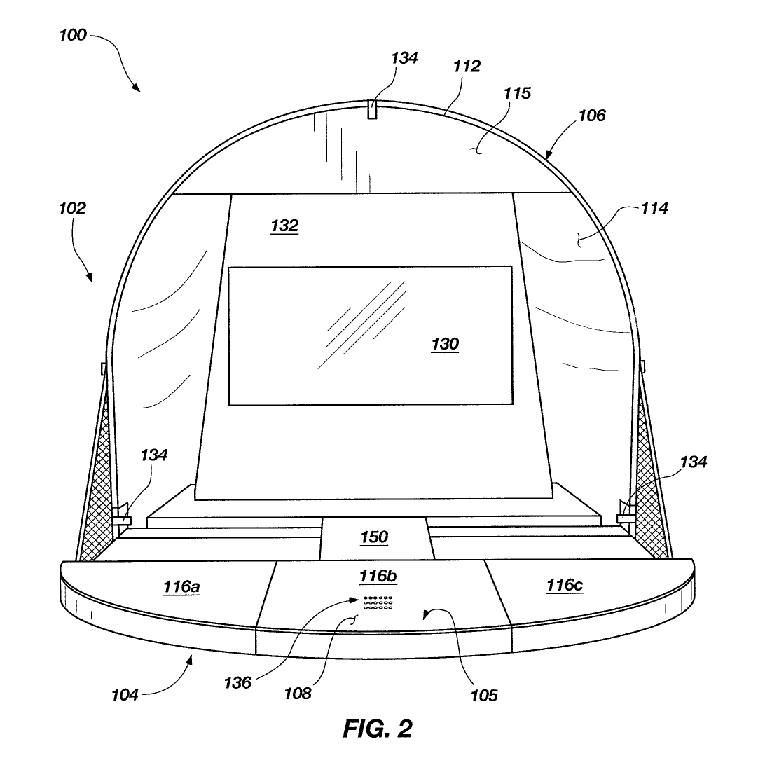

FIGS. 1 and 2 illustrate an embodiment of a collapsible golf simulator 100 of the present invention. The golf simulator 100 includes a collapsible stage 102 comprising a base 104 and an enclosure 106 mounted over the base 104. The base 102 may comprise a platform 105 having (e.g., carrying) an upper play surface 108 that is configured to support a person using the golf simulator 100. The upper play surface 108 may comprise, for example, a synthetic grass material. The enclosure 106 is configured to receive or capture a physical golf ball bit from the play surface 108 by a person using the golf simulator 100 upon stroke of a physical golf club against the physical golf ball by the person using the golf simulator 100.

The collapsible stage 102 is configured to transform between an expanded configuration, like that shown in FIGS. 1 and 2, in which the stage 102 is configured for use in simulating golf play, and a collapsed configuration, in which the stage 102 is configured for at least one of transportation and storage. The stage 102 may occupy a smaller volume of space, and may have a smaller footprint area in the collapsed configuration relative to the expanded configuration. As a non-limiting example, the stage 102 may have a maximum footprint area of about five (5) square meters or less, or even about four (4) square meters or less in the collapsed configuration. Furthermore, in some embodiments of the invention, the stage 102 may have a total weight of about one hundred thirty-six (136) kilograms (about 300 pounds) or less, about one hundred thirteen (113) kilograms (about 250 pounds) or less, or even about ninety (90) kilograms (about 200 pounds) or less to facilitate transportation of the golf simulator 100.

As shown in FIG. 1, the enclosure 106 may comprise a plurality of arcuate rib members 112 each having a first end pivotally mounted to the base 104 at a first lateral side thereof, and an opposite, second end pivotally mounted to the base 104 at a second lateral side thereof. A bracket 118 may be provided on each lateral side of the base 104, and the ends of each of the arcuate rib member 112 may be pivotally attached to the bracket 118. In this configuration, each of the arcuate rib members 112 is configured to pivot relative to the base 104 between an extended position (the position shown in FIGS. 1 and 2) and a collapsed position, as discussed in further detail hereinbelow.

As used herein, the term “front” refers to the portion of a stage 102, or the portion of a component of a stage 102, that is located toward the end of the stage 102 from which a person using the stage 102 hits golf balls into the enclosure 106, and the term “back” refers to the portion of a stage 102, or the portion of a component of a stage 102, that is located toward the end of the stage toward which a person using the stage 102 hits golf balls. For example, the play surface 108 is located toward the front of the stage 102, and the enclosure 106 is located toward the back of the stage 102.

Although obscured from view in many of the figures, each of the arcuate rib members 112 may comprise two substantially similar arcuate bars that are connected in an end-to-end manner by a rib hinge. A first end of each of the arcuate bars may be pivotally coupled to the rib hinge, and a second end of each of the arcuate bars may be pivotally attached to one of the respective brackets 118 provided on each of the lateral sides of the base 104. Thus, each arcuate rib member 112 is configured to fold at the rib hinge when the plurality of arcuate rib members 112 are collapsed over and onto the base 104, and the base 104 and the enclosure 106 are folded, as described below.

In some embodiments, each of the arcuate rib members 112 may have a slightly different shape, to allow the arcuate rib members 112 to lay at least substantially flat against the base 104 in the collapsed configuration, and in substantially a common plane. For example, the enclosure 106 may include four arcuate rib members 112, as shown in FIG. 1, The distance between the ends of each of the arcuate rib members 112 may be the same (e.g., approximately three (3) meters (10 feet)), and approximately equal to the distance between the brackets 118. The minimum distances between the midpoints of the arcuate rib members 112 and an imaginary line extending between the brackets 118, however, may be different for one or more of the arcuate rib members 119. For example, the minimum distance between the midpoint of the first, foremost arcuate rib member 112 and an imaginary line extending between the brackets 118 may be approximately 2.6 meters (8.5 feet). That same distance for the next, second arcuate rib member 112 may be approximately 2.9 meters (9.5 feet). The same distance for the next, third arcuate rib member 112 may be approximately 2.7 meters (9 feet). And the same distance for the fourth, aftmost arcuate rib member 112 may be approximately 2.6 meters (8.5 feet).

A sheet 114 may be supported by (e.g., provided over or under, and attached to) the arcuate rib members 112. The sheet 114 may comprise a pliable material, such as, for example, a sheet of woven fabric or a substantially continuous sheet of polymeric material (e.g., a plastic or elastomeric material). The sheet 114 may be configured to absorb the kinetic energy of golf balls hit into the enclosure 106 so as to reduce the occurrence ricochet of golf balls out from the enclosure 106 toward a user or other persons. A retention sheet 115 also may be attached to the foremost arcuate rib member 112 that extends across a top portion of the opening leading into the enclosure 106. The retention sheet 115 may serve to further retain golf balls within the enclosure 106 after they have been hit into the enclosure by a user, thereby further reducing the occurrence of ricochet of golf balls out from the enclosure 106 toward a user or other persons.

In this configuration, the shape of the enclosure 106 may define a portion of a torroid in the extended configuration. The opening leading into the enclosure 106 (i.e., the opening to the enclosure 106 through which golf balls are hit by a user) may have a semispherical or semielliptical shape. In some embodiments, the opening to the enclosure 106 may have a maximum radius of about two (2.0) meters or less, or even about one and one-half (1.5) meters or less.

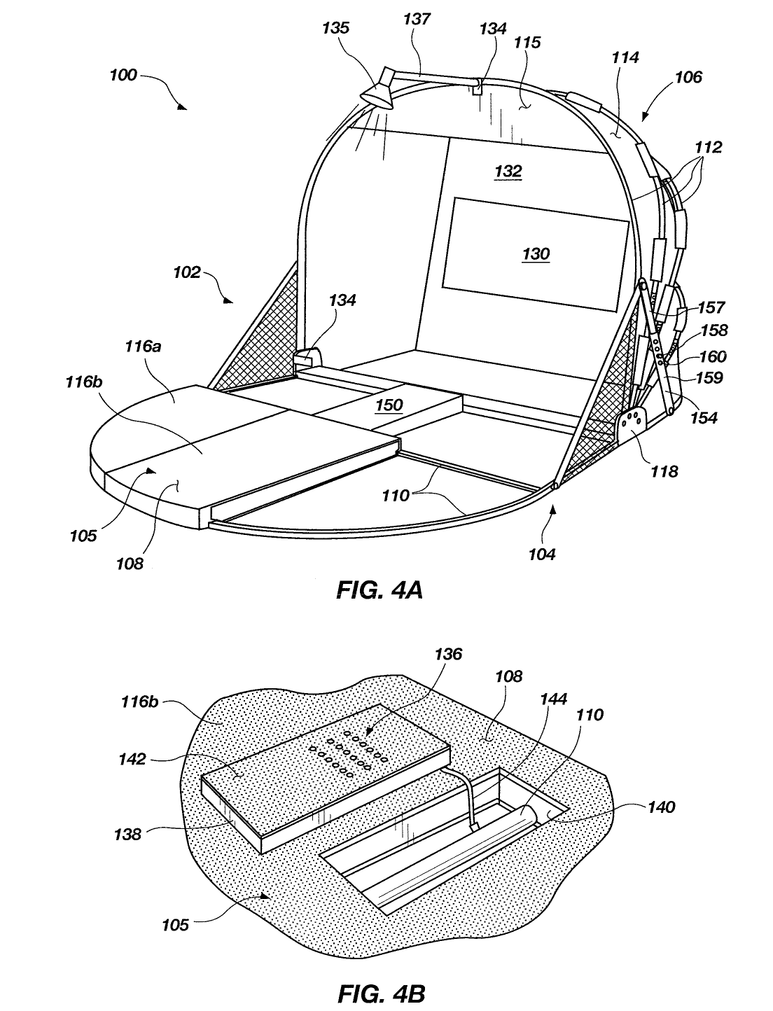

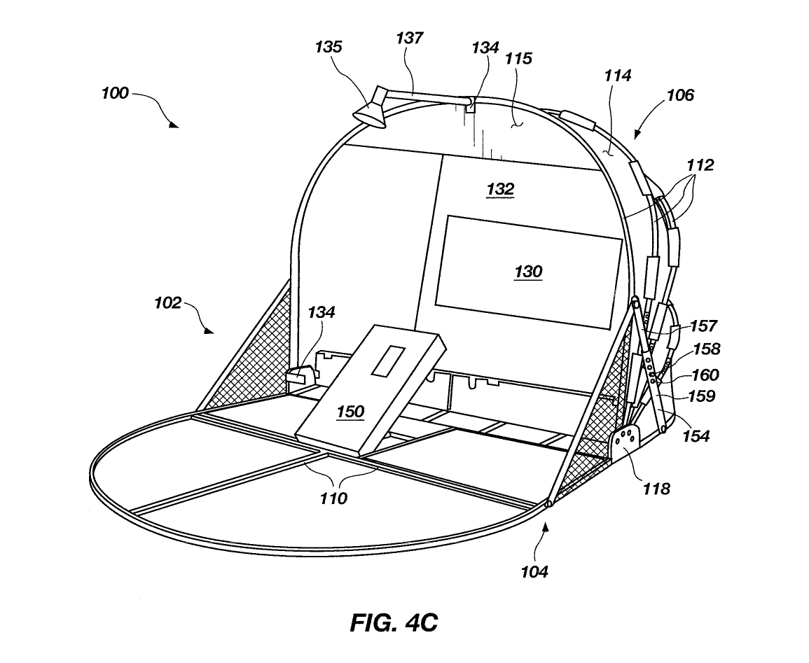

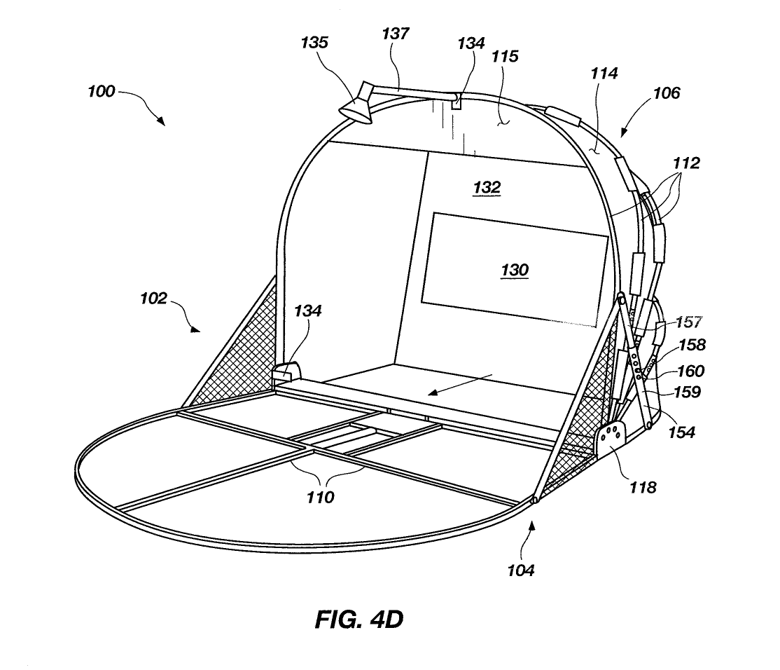

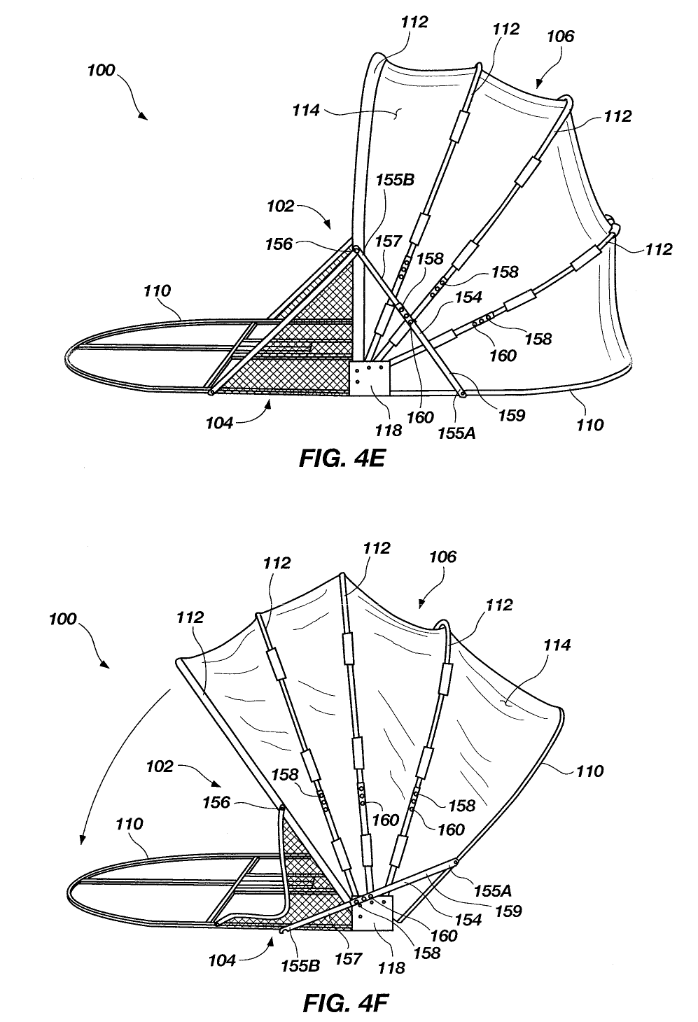

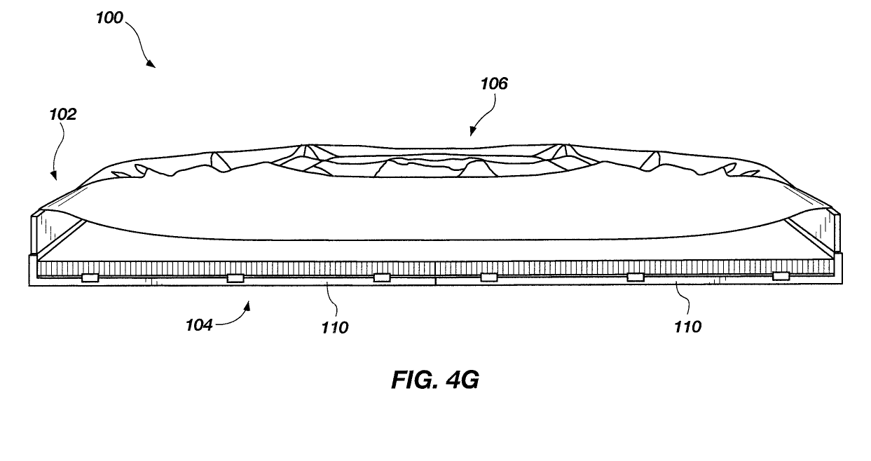

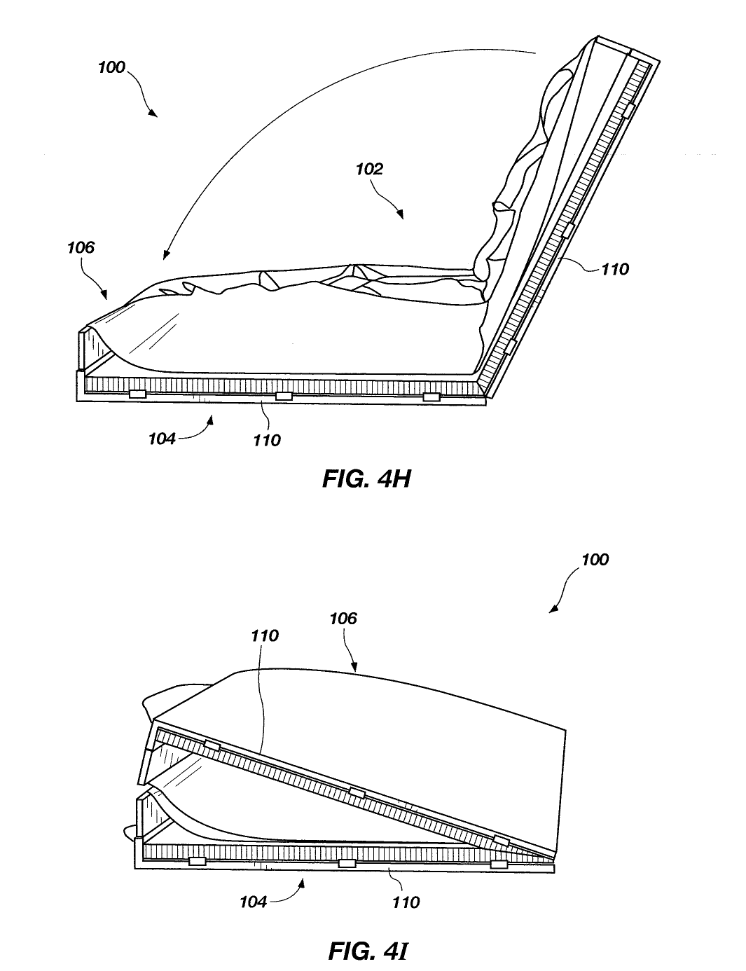

The base 104 may comprise a base frame 110 (see FIG. 4C) that includes a first lateral side, and an opposite, second lateral side. As discussed below, a back portion of the base frame 110 may be configured to fold over and onto the front portion of the base frame 110 about an axis or plane extending between the back and front portions of the base frame 110. The base frame 110 also may be configured to allow one lateral side portion of the base frame 110 to fold over and onto an opposite lateral side portion of the base frame 110 after folding be back portion of the base frame 110 over and onto the front portion of the base frame 110. A front end of each of the first lateral side member and the second lateral side member may be coupled together by way of at least two front end members (which may be arcuate, as shown in the figures). A back end of each of the first lateral side member and the second lateral tide member may be coupled together by way of at least two back end members. The front end members may be coupled together by at least one hinge, and the back end members may be coupled together by at least one hinge, to allow the base 104 to be folded in half about an axis (or plane) extending through each of the first hinge and the second hinge, as discussed in further detail below, which may reduce a footprint area of the base 104.

The platform 105 of the base 104 may comprise, or be defined by, plurality of removable base panels 116a, 116b, . . . 116n. The removable base panels 116a, 116b, . . . 116n may comprise, for example, a material having a density of about thirty (30) kilograms per cubic meter or less. As a non-limiting example, the removable base panels 116a, 116b, . . . 116n may comprise a polymeric foam material such as, for example, a closed-cell crosslinked polyethylene foam such as that sold by Cellect LLC of St. Johnsville, N.Y. under the name SSP-20.

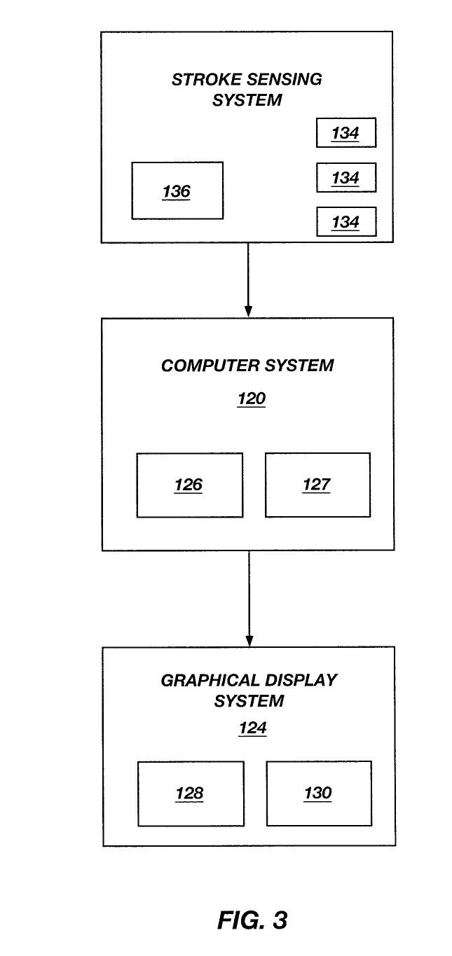

Referring to FIG. 3, the golf simulator 100 may further comprise a computer system 120, a physical golf stroke sensing system 122, and a graphical display system 124. The computer system 120 may comprise a computer program configured to simulate golf play. The computer system 120 includes at least one electronic signal processor (e.g., a microprocessor), and at least one memory device (e.g., one or more of an optical drive, a hard disc drive, and random access memory (RAM)). In some embodiments, the computer system 120 may comprise a commercially available desktop or laptop computer system. The computer system 120 comprises a computer program configured to simulate golf play. For example, a golf game computer program may be stored in a memory device of the computer system 120 (e.g., stored in memory of a hard disc drive or stored on an optical disc, such as a compact disc (CD) or a digital video disc (DVD) located in an optical drive of the computer system 120).

The graphical display system 124 may be in electrical communication with the computer system 120, and may be configured to display images generated by the computer program. For example, in some embodiments, the graphical display system 124 may comprise an image projector device 128 and a screen 130 onto which the image projector device 128 is configured to project images generated by the computer program and the computer system 120. The screen 130 may be mounted to the stage 102 within the enclosure 106 when the stage 102 is in the expanded configuration, as shown in FIGS. 1 and 2. Thus, an image of a golf course (i.e., from the viewpoint of a tee box or a location along a fairway of a golf hole looking toward a green of the hole) may be projected onto the screen 130, and a user may hit a physical golf ball into the enclosure against the screen 130 from the play surface 108 of the stage 102.

The physical golf stroke sensing system 122 may be in electrical communication with the computer system 120, and may be configured to sense at least one characteristic of a physical stroke of a physical golf club against a physical golf ball by a person using the golf simulator apparatus, and to input information relating to the at least one characteristic into the computer system. The at least one characteristic may comprise, for example, one or more of a speed of the golf ball, a speed of the golf club at the time of impact with the golf ball, a location at which the golf ball impacts a surface of the stage 102 (e.g., a surface of the screen 130 or panel 132), and an orientation of a the golf club (e.g., an orientation of the face of the golf club) at the time of impact with the golf ball. The computer program may be configured to simulate a virtual golf stroke in the computer program using the information relating to the at least one characteristic of the physical stroke of the physical golf club against the physical golf ball. For example, the computer program may use information received or obtained from the physical golf stroke sensing system 122 to generate a velocity and spin of a virtual golf ball, and a resulting trajectory of the virtual golf ball, in the golf game, which virtual trajectory of the golf ball may be displayed on the screen 130 using the graphical display system 124.

By way of example and not limitation, the golf stroke sensing system 122 may comprise three ultrasonic transducers 134 located and configured to detect a time of impact between the golf club and the golf ball for a physical golf stroke performed by a user, to detect a time at which the golf ball impacts a surface of the stage 102 (e.g., a surface of the screen 130), and to detect a location at which the golf ball impacts a surface of the stage 102. Principles of triangulation may be used to detect the location at which the golf ball impacts a surface of the stage 102. The approximate location of impact between the golf club and the golf ball (i.e., the location from which a golf ball is hit on the play surface 108) may be the same for each stroke, and may be pre-programmed into the computer system 120. The amount of time lapsing between the time of impact between the golf club and the golf ball and the time of impact between the golf ball and the surface of the stage 102 may be used to determine a speed of the golf ball. The difference between the location at which the golf ball impacts the surface of the stage 102 and the location at which impact occurs between the golf club and the golf ball may be used to determine a direction of the trajectory of the golf ball. The known speed and the known direction of the golf ball then may be used to provide a velocity vector for a virtual golf ball in the golf game. The three ultrasonic transducers 134 may be mounted, for example, to the foremost arcuate rib member 112 located at the opening to the volume of space surrounded by the enclosure 106. One ultrasonic transducer 134 may be mounted proximate each end of the arcuate rib member 112 near the base 104 (i.e., at the lower lateral sides of the opening leading to the volume of space surrounded by the enclosure 106), and one ultrasonic transducer 134 may be mounted at or near the midpoint along the foremost arcuate rib member 112 (i.e., at the top center of the opening leading to the volume of space surrounded by the enclosure 106).

The golf stroke sensing system 122 may further comprise an array of sensors 136 (FIG. 4B) disposed within the play surface 108. The array of sensors 136 may be configured to sense at least one of a speed of the golf club and an orientation of the golf club (e.g., an orientation of the face of the golf club) during a physical stroke (e.g., at or near the time of impact with the golf ball) of a physical golf club against a physical golf ball by a person using the golf simulator 100. As discussed in further detail below, the array of sensors 136 may be carried by a sensor module 138, which may be removably mounted in a recess 140 extending into the play surface 108, as shown in FIG. 4B. The sensor module 138 may have an upper surface 142 that is at least substantially flush with, and that defines a portion of, the play surface 108. In some embodiments, a lamp 135 may be positioned at the end of an elongated member 137 protruding toward the front of the golf simulator 100 at the apex of the front-most arcuate rib member 112. The lamp 135 may emit light toward the array of sensors 136. Light impinging on the sensors 136 may cause the sensors 136 to generate an electronic signal. Thus, as a golf club, and, more specifically, a face of a head of a golf club, swings past the sensors 136, changes in the light impinging on the sensors 136 may cause the sensors 136 to generate a signal representative of at least one of the speed, direction of travel, and orientation of the face. Because the lamp 135 may provide additional light to the sensors 136, the lamp 135 may enable the sensors 136 in the array to sense at least one of the speed, direction of travel, and orientation of the golf club with increased accuracy and precision.

Referring again to FIG. 1, the golf simulator 100 may further include a container 150 that is configured to be removably mounted to the base 104 of the stage 102. In other words, the container 150 is configured to be mounted on the base 104 of the stage 102 in a manner that facilitates relatively quick and easy removal and re-mounting of the container 150 to the base 104. The container 150 may contain at least one component of at least one of the computer system 120 and the graphical display system 124 therein. In other words, at least a component of one or both of the computer system 120 and the graphical display system 124 may be disposed within the container 150. As a non-limiting example, the graphical display system 124 may include an image projector device 128 that is disposed within and mounted to the container 150. In such an embodiment, a hole may be provided through a back wall of the container 150, and the projector device 128 may be mounted within the container 150 in a position and orientation such that the projector device 128 projects an optical image (in the form of light) through the hole in the container 150 and onto a screen 130 mounted to the stage 102 within the enclosure 106. At least substantially the entire computer system 120 also may be disposed within and mounted to the container 150. In some embodiments, electrical couplings may be provided in or through one or more walls of the container 150 to facilitate electrical connection between components inside the container 150 (e.g., a computer system 120 and/or a projector device 128), and components outside the container 150 (e.g., a power supply and/or components of the golf stroke sensing system 122).

A recess may be formed or otherwise provided that extends into the platform 105 of the base 104, and the recess may be sized and configured to receive the container 150 therein. Thus, in such embodiments, the container 150 may be mounted to the base 104 by simply placing the container 150 within the corresponding recess in the platform 105, and establishing electrical connections as desirable between the various electrical components of the golf simulator 100. In other embodiments, a receptacle may be defined by a portion of the base frame 110, and the container 150 may be mounted to the base 104 by simply placing the container 150 within the corresponding receptacle defined in the base frame 110, and establishing electrical connections as desirable between the various electrical components of the golf simulator 100.

Embodiments of golf simulators of the present invention, such as the golf simulator 100 described above with reference to FIGS. 1 through 3, may be collapsed for at least one of storage and transportation of the golf simulators in accordance with embodiments of methods of the present invention. As an example of embodiments of methods of the present invention, a method of collapsing the golf simulator 100 illustrated in FIGS. 1 through 3 is described below with reference to FIGS. 4A through 4I.

Referring to FIG. 4A, the plurality of removable panels 116a, 116b, . . . 116n may be removed from the base 104 of the stage 102. In some embodiments, the plurality of removable panels 116a, 116b, . . . 116n may be sized and configured to engage the base frame 110 in such a manner that the panels 116a, 116b, . . . 116n may simply be lifted off from the base frame 110 without requiring removal of any fasteners, etc. As shown in FIG. 4B, prior to removing the panel 116b that includes the sensor module 138, which carries the array of sensors 136, the sensor module 138 may be removed from the recess 140 in which the sensor module 138 is disposed. Any cable 144 electrically connecting the sensor module 138 to the computer system 120 may be unplugged to allow the sensor module 138 to be removed from the base 104.

Referring to FIG. 4C, the container 150 may be removed from the base 104. In some embodiments, the container 150 may be sized and configured to engage the base frame 110 in such a manner that the container 150 may simply be lifted off from the base frame 110 without requiring removal of any fasteners, etc. Any cable or cables electrically connecting the components within the container 150 to wires carried by the base 104 (e.g., a wire extending through or along a tubular member of the base frame 110 from proximate the container 150 to proximate the sensor module 138) may be unplugged to allow the container 150 to be removed from the base 104.

Referring to FIG. 4D, the screen 130 may be mounted to or comprise a part of a substantially planar panel 132. The top edge of the panel 132 may be fixedly attached to sheet 114 and/or to one of the arcuate rib members 112, but the side and bottom edges of the panel 133 may not be fixedly attached to any portion of the stage 102, such that the panel 132 may swing or pivot relative to the top edge of the panel 132. In some embodiments, however, one or more of the side and bottom edges of the panel 133 may be temporarily secured to another component of the stage 102 (e.g., using so-called “hook and loop” fastener material such as, for example, VELCRO) when the stage 102 is in the expanded state to prevent unwanted movement of the panel 132. To collapse the enclosure 106, the bottom edge of the panel 132 may be pulled toward the front of the base 104, as indicated by the directional arrow, to ensure that the panel 132 will lay at least substantially flat against the base 104 as the enclosure 106 is collapsed, as discussed below.

Referring to FIG. 4E, a support bar 154 may be provided on one or both lateral sides of the stage 102 for securing the enclosure 106 in the expanded state. One end 155A of each support bar 154 may be fixedly attached to base 104, and an opposite, second end 155B of each support bar 154 may be attachable in a releasable manner to a pin 156 provided on the foremost arcuate rib member 112. To collapse the enclosure 106, the second ends 155B of the support bars 154 may be disengaged from the pins 156, and the arcuate rib members 112 and a back portion of the base 104 then may be folded toward the front of the stage 102 and onto a front portion of the base 104, as shown in FIG. 4F. Hinges (not shown) may be provided between the front portion of the base 104 and the back portion of the base 104 to enable the folding action illustrated in FIG. 4F. In some embodiments, the support bar 154 may be extensible. For example, the support bar 154 may comprise at least two support members, a first support member 157 comprising a pin 158 and at least another support member 159 comprising at least one hole 160. The pin 158 of the first support member 157 may be spring loaded, for example, enabling the pin 158 to be retracted and the first support member 157 to be inserted partially within the at least another support member 159 without obstruction. The pin 158 may then be released and positioned to at least partially protrude through the at least one hole 160 in the at least another support member 159, securing the first support member 157 to the at least another support member 159. In some embodiments, the at least another support member 159 may comprise a plurality of holes 160, enabling the assembled support bar 154 to be of varying lengths as the pin 158 is positioned in holes 160 at various positions along the length of the at least another support member 159. In embodiments where the support bar 154 is extensible, the extensible support bar 154 may enable easier assembly of the collapsible golf simulator 100, especially in spaces of with little vertical space, such as a room with a ceiling about nine feet above the floor.

FIG. 4G is a back plan view of the stage 102 after folding the arcuate rib members 112 and the back portion of the base 104 onto the front portion of the base 104, as shown in FIG. 4F. As shown in FIG. 4H, one lateral side of the base 104 and the arcuate rib members 112 may be folded over onto the opposite lateral side of the base 104 and the arcuate rib members 112. Hinges (not shown) may be provided between the opposite lateral sides of the base 104 and along the arcuate rib members 112 to enable the folding action illustrated in FIG. 4F.

FIG. 4I illustrates the golf simulator 100 in the completely collapsed configuration attained upon performing the folding action illustrated in FIG. 4H. In this collapsed configuration, the golf simulator 100 may have a significantly reduced footprint area (the total square area on the ground or floor covered by the golf simulator 100 when oriented on the ground or floor as shown in the Figures). For example, the golf simulator 100 may have a footprint area in the collapsed configuration (FIG. 4I) that is about thirty-five (35) percent or less of the footprint area in the expanded configuration (FIGS. 1 and 2), about thirty (30) percent or less of the footprint area in the expanded configuration, or even about twenty-five (25) percent or less of the footprint area in the expanded configuration.

Thus, in accordance with some embodiments of the invention, the collapsible enclosure 106 is collapsed from an expanded configuration (shown in FIGS. 1 and 2), in which the enclosure 106 is configured for use in simulating golf play, to a collapsed configuration (shown in FIG. 4I), in which the enclosure 106 is configured for at least one of transportation and storage.

The collapsed enclosure 106 and the base 104 attached to the collapsed enclosure 106 then may be folded to reduce a maximum footprint area of the golf simulator 100 and a volume of space occupied by the golf simulator 100.

In some embodiments, the plurality of arcuate rib members 112 attached to the base 104 may be pivoted relative to the base as the enclosure 106 is collapsed from the expanded configuration to the collapsed configuration. Furthermore, in some embodiments, the arcuate rib members 112 are folded as the collapsed enclosure 106 and the base 104 attached to the collapsed enclosure 106 are folded. In some embodiments, at least some of the arcuate rib members 112 may be extensible. For example, the arcuate rib members 112 may comprise at least two support members, a first support member comprising a pin 158 and at least another support member comprising at least one hole 160. The pin 158 of the first support member may be spring loaded, for example, enabling the pin 158 to be retracted and the first support member to be inserted partially within the at least another support member without obstruction. The pin 158 may then be released and positioned to at least partially protrude through the at least one hole 160 in the at least another support member, securing the first support member to the at least another support member. In some embodiments, the at least another support member may comprise a plurality of holes 160, enabling the assembled arcuate rib member 112 to be of varying lengths as the pin 158 is positioned in holes 160 at various positions along the length of the at least another support member. In embodiments where the arcuate rib member 112 is extensible, the extensible arcuate rib member 112 may enable easier assembly of the collapsible golf simulator 100, especially in spaces of with little vertical space, such as a room with a ceiling about nine feet above the floor. In some embodiments, the container 150 may be removed from the base 104 prior to folding the collapsed enclosure 106 and the base 104. As previously mentioned, the container 150 may contain therein the computer system 150 and a projector device 128 in some embodiments.

The sensor module 138 may be removed from the base 104 prior to folding the collapsed enclosure 106 and the base 104. As previously discussed, the sensor module 138 may contain an array of sensors 136 configured to sense at least one of a speed and an orientation of a physical golf club during a physical stroke of the physical golf club against a physical golf ball by a person using the golf simulator 100.

At least one platform panel 116a, 116b, . . . 116n may be removed from the base 104 prior to folding the collapsed enclosure 106 and the base 104.

To return the golf simulator 100 to the expanded configuration shown in FIGS. 1 and 2, the actions described with reference to FIGS. 4A through 4I may simply be reversed.

Although the foregoing description contains many specifics, these are not to be construed as limiting the scope of the present invention, but merely as providing certain exemplary embodiments. Features shown and described in one embodiment of the invention may be incorporated into other embodiments of the invention. Other embodiments of the invention may be devised that do not depart from the spirit or scope of the present invention. The scope of the invention is, therefore, indicated and limited only by the appended claims and their legal equivalents, rather than by the foregoing description. All additions, deletions, and modifications to the invention, as disclosed herein, which fall within the meaning and scope of the claims are encompassed by the present invention.

What is claimed is:

1. A golf simulator apparatus, comprising:
a computer system comprising a computer program configured to simulate golf play;
a graphical display system in electrical communication with the computer system and configured to display images generated by the computer program;
a physical golf stroke sensing system in electrical communication with the computer system and configured to sense at least one characteristic of a physical stroke of a physical golf club against a physical golf ball by a person using the golf simulator apparatus and to input information relating to the at least one characteristic into the computer system, the computer program configured to simulate a virtual golf stroke in the computer program using the information relating to the at least one characteristic of the physical stroke of the physical golf club against the physical golf ball; and
a stage comprising:
a base having a play surface configured to support a person using the golf simulator apparatus; and
an enclosure mounted over the base and configured to receive a physical golf ball hit from the play surface by a person using the golf simulator apparatus upon stroke of a physical golf club against the physical golf ball by the person using the golf simulator apparatus; and
a container configured to be removably mounted to the base of the stage, at least one component of at least one of the computer system and the graphical display system disposed within the container.

2. The golf simulator apparatus of claim 1, wherein the graphical display system comprises:
a screen mounted to the stage within the enclosure; and
a projector device mounted in the container and configured to project images generated by the computer system onto the screen.

3. The golf simulator apparatus of claim 1, wherein the computer system is mounted within the container.

4. The golf simulator of claim 1, wherein the base comprises:
a platform carrying the play surface; and
a recess extending into the platform, the recess sized and configured to receive the container therein.

5. The golf simulator of claim 4, wherein the platform comprises a plurality of removable panels.

6. The golf simulator of claim 5, wherein the removable panels comprise a material having a density of about thirty (30) kilograms per cubic meter or less.

7. The golf simulator of claim 1, wherein the physical golf stroke sensing system comprises an array of sensors disposed within the play surface and configured to sense at least one of a speed and an orientation of a physical golf club during a physical stroke of the physical golf club against a physical golf ball by a person using the golf simulator apparatus.

8. The golf simulator of claim 7, wherein the physical golf stroke sensing system further comprises at least one sensor configured to detect a location of impact of a physical golf ball against at least one surface of the golf simulator apparatus.

9. The golf simulator of claim 7, wherein the array of sensors is carried by a sensor module removably mounted in a recess extending into the play surface.

10. The golf simulator of claim 9, wherein the sensor module has an upper surface at least substantially flush with, and defining a portion of, the play surface.

11. A golf simulator apparatus, comprising:
a computer system comprising a computer program configured to simulate golf play;
a graphical display system in electrical communication with the computer system and configured to display images generated by the computer program;
a physical golf stroke sensing system in electrical communication with the computer system and configured to sense at least one characteristic of a physical stroke of a physical golf club against a physical golf ball by a person using the golf simulator apparatus and to input information relating to the at least one characteristic into the computer system, the computer program configured to simulate a virtual golf stroke in the computer program using the information relating to the at least one characteristic of the physical stroke of the physical golf club against the physical golf ball; and
a collapsible stage configured to transform between a collapsed configuration in which the collapsible stage is configured for at least one of transportation and storage and an expanded configuration in which the collapsible stage is configured for use in simulating golf play, the collapsible stage comprising:
a base having a play surface configured to support a person using the golf simulator apparatus; and
a collapsible enclosure mounted over the base and configured to receive a physical golf ball hit from the play surface by a person using the golf simulator apparatus upon stroke of a physical golf club against the physical golf ball by the person using the golf simulator apparatus, the collapsible enclosure comprising:
a plurality of arcuate rib members each having a first end pivotally mounted to the base at a first lateral side thereof and an opposite second end pivotally mounted to the base at a second lateral side thereof, each arcuate rib member of the plurality of arcuate rib members configured to pivot relative to the base between an extended position and a collapsed position; and
a sheet of pliable material carried by the plurality of arcuate rib members.

12. The golf simulator apparatus of claim 11, wherein the base is configured to fold to reduce a footprint area thereof.

13. The golf simulator apparatus of claim 12, wherein the base includes a base frame comprising:
a first lateral side member;
an opposite, second lateral side member;
at least two front end members coupled together by a first hinge; and
at least two back end members coupled together by a second hinge;
wherein the base frame is configured to fold along a plane extending through the first hinge and the second hinge.

14. The golf simulator apparatus of claim 13, wherein each arcuate rib member of the plurality of arcuate rib members comprises:
a rib hinge;
a first arcuate bar having a first end pivotally coupled to the rib hinge and an opposite, second end pivotally coupled to the first lateral side member of the base frame; and
a second arcuate bar having a first end pivotally coupled to the rib hinge and an opposite, second end pivotally coupled to the opposite, second lateral side member of the base frame;
wherein each arcuate rib member of the plurality of arcuate rib members is configured to fold at the rib hinge when the plurality of arcuate rib members are in the collapsed position and the base frame is folded along the plane extending through the first hinge and the second hinge.

15. The golf simulator apparatus of claim 11, wherein the stage has a total weight of about 136 kilograms or less.

16. The golf simulator apparatus of claim 11, wherein the stage has a maximum footprint area of about four (4.0) square meters or less in the collapsed configuration.

17. The golf simulator apparatus of claim 11, wherein the graphical display system comprises:
a screen mounted to the stage within the enclosure; and
a projector device configured to project images generated by the computer system onto the screen.

18. The golf simulator apparatus of claim 11, wherein the base of the collapsible stage comprises a platform including a plurality of removable panels.

19. The golf simulator apparatus of claim 18, wherein the removable panels comprise a material having a density of about thirty (30) kilograms per cubic meter or less.

20. The golf simulator apparatus of claim 11, wherein the physical golf stroke sensing system comprises an array of sensors disposed at the play surface and configured to sense at least one of a speed and an orientation of a physical golf club during a physical stroke of the physical golf club against a physical golf ball by a person using the golf simulator apparatus.

21. The golf simulator apparatus of claim 20, wherein the physical golf stroke sensing system further comprises at least one sensor configured to detect a location of impact of a physical golf ball against at least one surface of the golf simulator apparatus.

22. The golf simulator apparatus of claim 20, wherein the array of sensors is carried by a sensor module removably mounted in a recess extending into the play surface.

23. The golf simulator apparatus of claim 22, wherein the sensor module has an upper surface at least substantially flush with, and defining a portion of, the play surface.

24. The golf simulator apparatus of claim 11, further comprising a container configured to be removably mounted to the base of the stage, at least one component of at least one of the computer system and the graphical display system disposed within the container.

25. The golf simulator apparatus of claim 24, wherein the computer system is mounted within the container.

26. The golf simulator apparatus of claim 24, wherein the base comprises:
a platform carrying the play surface; and
a recess extending into the platform, the recess sized and configured to receive the container therein.

27. A method of transporting or storing a golf simulator apparatus, comprising:
collapsing a collapsible enclosure from an expanded configuration in which the collapsible enclosure is configured for use in simulating golf play to a collapsed configuration in which the collapsible enclosure is configured for at least one of transportation and storage; and
folding the collapsed enclosure and a base attached to the collapsed enclosure to reduce a maximum footprint area of the golf simulator apparatus and a volume of space occupied by the golf simulator apparatus.

28. The method of claim 27, wherein collapsing the collapsible enclosure from the expanded configuration to the collapsed configuration comprises pivoting a plurality of arcuate rib members attached to the base relatively to the base.

29. The method of claim 28, wherein folding the collapsed enclosure and the base attached to the collapsed enclosure comprises folding the arcuate rib members.

30. The method of claim 27, further comprising removing a container from the base prior to folding the collapsed enclosure and the base, the container containing a computer system and an image projector of the golf simulator apparatus.

31. The method of claim 27, further comprising removing a sensor module from the base prior to folding the collapsed enclosure and the base, the sensor module containing an array of sensors configured to sense at least one of a speed and an orientation of a physical golf club during a physical stroke of the physical golf club against a physical golf ball by a person using the golf simulator apparatus.

32. The method of claim 27, further comprising removing at least one platform panel from the base prior to folding the collapsed enclosure and the base, the at least one platform panel having an upper surface defining a play surface of the golf simulator apparatus.
